(19) United States
(12) Patent Application Publication
(10) Pub. No.: US 2003/0161923 A1
(43) Pub. Date: Aug. 28, 2003

(54) Frozen beverage apparatus

(76) Inventors: Joseph Eugene Holland, Birmingham (GB); David Carter, Watlington (GB); Carolyn Janet Jury, Leichhardt (AU)

Correspondence Address: Sten Erik Hakansan, Patent Attorney, IMI Cornelius Inc., One Cornelius Place, Anoka, MN, 55303-6234, US

(21) Appl. No.: 09/962,563

(22) Filed: Sep. 24, 2001

(30) Foreign Application Priority Data
Oct. 3, 2000 (GB) GB0024251.1
Sep. 22, 2000 (GB) GB0023410.4

(51) Int. Cl. A23C 3/00

(52) U.S. Cl. 426/524

(57) ABSTRACT

Apparatus for dispensing a semi-frozen beverage is disclosed in which a freeze cylinder 12 for converting a beverage to a desired semi-frozen condition is positioned at a remote location from a dispense tap 10. The freeze cylinder 12 is connected to the tap 10 by a flow line 13 for maintaining the semi-frozen condition of the beverage between the freeze cylinder 12 and the tap 10. The flow line 13 may be insulated and additional cooling may be provided between freeze cylinder 12 and the tap 10. The flow line 13 may be in the form of a re-circulation loop for returning semi-frozen beverage to the freeze cylinder 12 for re-conditioning. A dosing unit 71 may be provided for adding flavours, spirits or other components to the semi-frozen beverage such that a range of beverages may be provided for dispense from the tap 10.

### FIELD OF THE INVENTION

The invention herein concerns improvements in or relating to apparatus for dispensing a semi-frozen beverage.

### BACKGROUND OF THE INVENTION

Semi-frozen or slush ice beverage producing and dispensing machines are well known in the art. Typically, a cylinder is cooled by a refrigeration evaporator wound around an external surface thereof. Water and a particular flavouring are added into the cylinder and mixed therein by the action of a scraper mechanism. Operation of a refrigeration system causes a fraction of the mixture to solidify on the internal surface of the cylinder. The scraper mechanism is then rotated to remove that fraction so that over time the entire interior volume of the cylinder is eventually filled with a semi-frozen slush beverage. A problem with existing slush dispensers lies in the fact that the number of flavours of beverage that a slush ice making machine can dispense at any one time is limited by the number of freeze cylinders present in the machine. Thus, any one machine is typically limited to 1 to 4 flavours. Change of flavour requires the flushing of each cylinder with the subsequent reconnection of a syrup delivery line thereof to an alternate syrup flavouring source. To provide customers with a wide array of flavoured slush beverages requires the purchase and installation of multiple machines having the total number of cylinders as is needed to match the desired number of flavours. However, slush beverage making and dispensing machines are generally quite large and/or take up valuable countertop space, and are relatively expensive to purchase and operate, especially for small retail locations. Accordingly, it would be very desirable to have a semi-frozen beverage dispensing machine that is capable of dispensing a wide variety of flavoured beverages and not restricted by requiring the dedication of each of its on or more cylinders to a particular flavour.

Semi-frozen beverage making and dispensing equipment is also hampered by the fact that it is restricted to dispensing the slush beverage from each cylinder through a spigot secured in very close proximity or directly to an end of each cylinder. This lack of location of dispense flexibility is significant in a bar situation wherein the bartender is required to go directly to the machine to dispense the drink flavoured slush, for example, a margarita flavoured slush mix. Whereas, from an efficiency point of view, it would be more desirable to have some flexibility as to the point of dispense and have such dispensing capacity ideally at one or more drinks preparation stations. This ability would also provide for more flexibility in where the slush machine could be located. However, the problem with a dispense point being remote from the slush equipment is the concern of the melting of the slush beverage as it travels from the freeze cylinder to the remote dispense point. Accordingly, it would be desirable to have a slush drink making and dispensing machine that can dispense slush beverage produced therein to a remote location without diminution of the frozen quality of the beverage and do so in an economical manner.

### SUMMARY OF THE INVENTION

Accordingly, the invention provides an apparatus to dispense a semi-frozen beverage which comprises freezing means for freezing a liquid to a desired semi-frozen state, and a flow line from the freezing means to a dispense tap, the dispense tap being mounted remotely from the freezing means. Thus, it will be appreciated that the dispense tap may be mounted, for example, above a bar counter, and may be fitted into a font-type housing, e.g. similar to those used for beer and lager dispense, while the freezing means may be hidden remote from the tap, e.g. under the bar counter. In this way, by separating the dispense tap from the freezing means, the apparatus can be used in different locations with the freezing means and dispense tap connected by the flow line. We have surprisingly found that it is possible to dispense a beverage in a semi-frozen condition via a flow line and a remote dispense tap without loss of the physical condition and appearance of the beverage.

The freezing means may be of any type conventionally used and may, for example, be a freeze cylinder as described in U.S. Pat. No. 5,103,649 with particular reference to FIGS. 4 to 7 thereof. The teaching of U.S. Pat. No. 5,103,649 in respect of its freeze cylinder arrangement and its electronic control system is by reference incorporated herein. The dispense tap may be any tap suitable for the dispense of semi-frozen beverage products, as is well known in the art. It is preferably connected to the flow line by a shut-off valve, e.g. a ball valve, that can normally be maintained open but which can be closed for removal of the tap for cleaning. The flow line for delivery of semi-frozen beverage to the tap may be a rigid or flexible tube of food grade material and is preferably insulated to reduce heat loss from the beverage in its travel from the freeze cylinder to the dispense tap. For example, the delivery tube may be encased in a sheath or jacket of thermally insulating material.

Alternatively, or additionally, the delivery tube may be cooled by a coolant flow line extending for all or a substantial portion of the length of the delivery tube. The coolant, which may conveniently be a glycol/water mixture, may be arranged to flow through a tube in heat exchange relationship with the beverage flowing through the delivery tube. In one arrangement, the coolant tube is arranged inside the delivery tube so that the coolant is surrounded by the beverage in the delivery tube. In another arrangement, the delivery tube is arranged inside the coolant tube so that the coolant surrounds the beverage in the delivery tube. The length of insulated delivery tube that can be employed without loss of physical condition and appearance of the semi-frozen beverage dispensed from the tap may limit the distance the tap can be spaced from the freeze cylinder.

In another embodiment, the flow line from the freeze cylinder to the dispense tap takes the form of a re-circulation loop where the semi-frozen beverage is returned to the freeze cylinder for re-freezing and re-circulation. In this way, the physical condition of the semi-frozen beverage flowing around the loop is maintained, especially between dispenses and the this may allow the tap to be positioned further from the freeze cylinder thereby further increasing the range of options for installing the apparatus. The re-circulation loop may be a rigid or flexible tube of food grade material and may be insulated to reduce heat loss as described previously. Alternatively or additionally, the beverage may be cooled by heat exchange with a coolant flowing in a coolant flow line as described previously. A pump may be provided in the re-circulation loop to assist flow of the semi-frozen beverage around the loop. The tap may be connected at any point around the loop and more than one tap may be connected. In this way, several taps may be arranged at different locations connected to the same freezing means. The beverage may be pre-mixed for supply to the freezing means. Alternatively, the beverage components may be mixed in the freeze cylinder. For example, a base liquid such as a water/alcohol or a water/sugar mixture, may be supplied to the freeze cylinder from one source and a flavour such as a syrup concentrate supplied from a separate source. The latter may be beneficial where separation of the pre-mixed beverage components may occur or where there is a risk of degradation of the pre-mixed beverage.

In another embodiment, a semi-frozen base liquid such as a water/alcohol or water/sugar mixture is delivered from the freeze cylinder in a semi-frozen condition to the dispense tap where a beverage component may be added to produce a desired beverage. For example, the semi-frozen base liquid may be modified by the addition of a flavour such as syrup concentrate. In a preferred arrangement, a dosing unit is provided at a low pressure point for addition of different beverage components to produce a range of beverages using the same semi-frozen base liquid. For example, the dosing unit may be controlled in response to user selection of a desired beverage to add the appropriate beverage component or combination of beverage components during dispense of the selected beverage. Alternatively, or additionally, the user may be able to select the additional component(s) to create a beverage of their choice. The dosing unit may comprise a manifold having separate inlets for each component with valves, e.g. solenoid valves for controlling the addition of each component. The additional components may be pumped or gravity fed. The valves may be arranged to open when the tap is opened or shortly thereafter and to close before dispense is completed to flush the system with the semi-frozen beverage and remove any trace of the added component(s). The valves may be set to dispense a pre-determined volume of the additional component(s). The invented apparatus has application for dispense of both alcoholic and non-alcoholic beverages which may be carbonated or non-carbonated.

### DESCRIPTION OF THE DRAWINGS

A better understanding of the structure, function, objects and advantages of the present invention and its various embodiments can be had by way of reading the following detailed description which refers to the following drawing figures, wherein:

FIG. 1 is a diagrammatic representation of one form of apparatus of the invention.

FIG. 2 is a side sectional view of a portion of one embodiment of the invention.

FIG. 3 is a similar view to FIG. 2 of another embodiment of the invention.

FIG. 4 is a similar view to FIGS. 2 and 3 of a further embodiment of the invention.

FIG. 5 is a diagrammatic representation of another form of apparatus of the invention.

FIG. 6 is a diagrammatic representation of a still further form of apparatus of the invention.

FIG. 7 is a diagrammatic representation of yet another form of apparatus of the invention.

FIG. 8 is a diagrammatic representation of yet a further form of apparatus of the invention.

FIG. 9 is a perspective view of a freeze cylinder unit for use in the invention.

FIG. 10 is a partially cut away side view of the freeze cylinder of FIG. 9.

FIG. 11 is an end view of the freeze cylinder of FIG. 9.

FIG. 12 is an enlarged view of a portion of the unit of FIG. 10 in the direction of arrows 12-12.

### DETAILED DESCRIPTION OF THE PREFERRED EMBODIMENTS

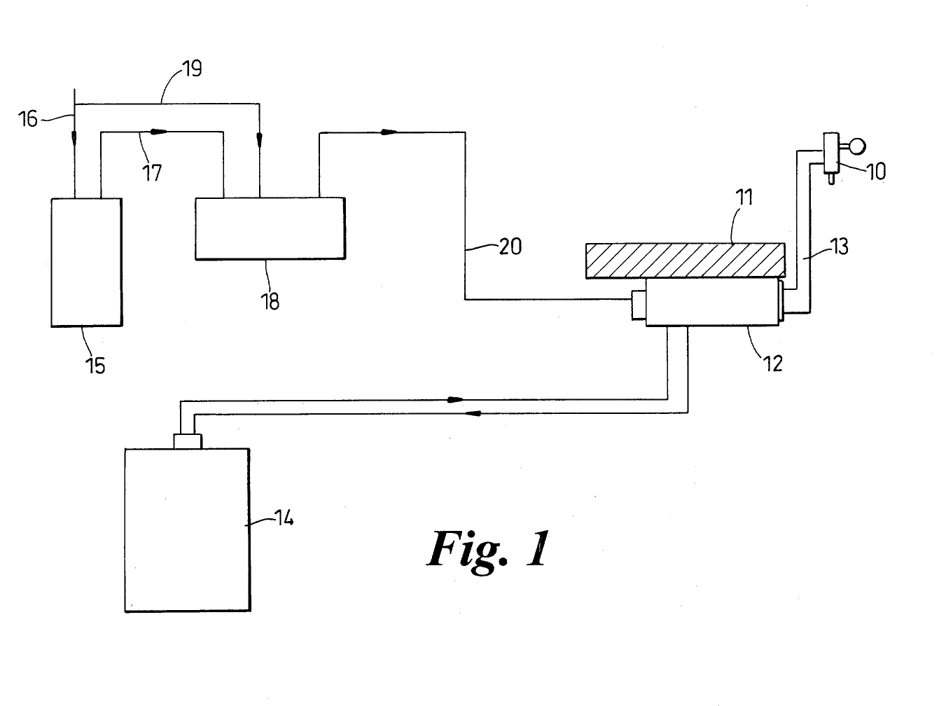

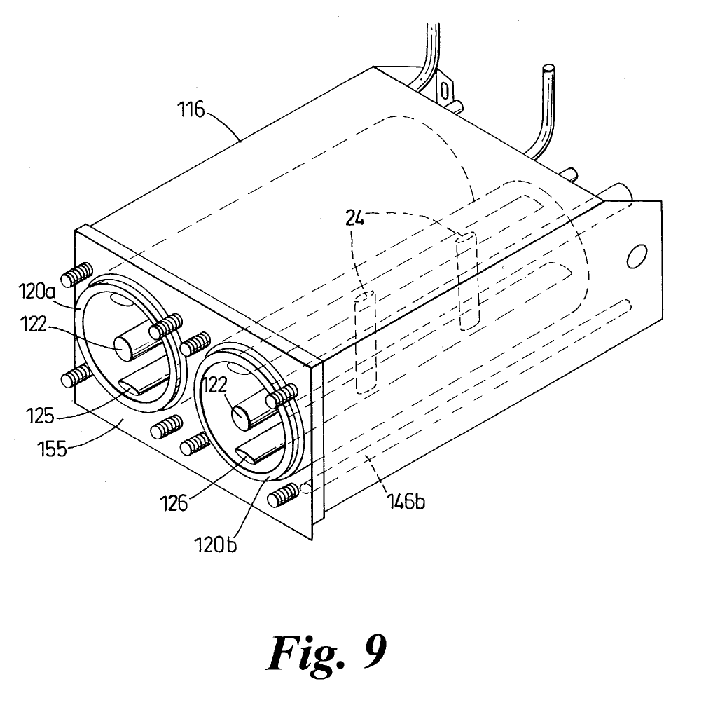

Referring first to FIG. 1, apparatus for dispensing a semi-frozen beverage is shown having a dispense tap 10 positioned above a bar top 11. The tap 10 may be mounted in a font-type housing, as indicated above, with consumer-appealing design and a commercial logo but is shown merely diagrammatically here. A freeze cylinder 12 is mounted beneath bar top 11 remote from the tap 10 and its outlet end is connected to tap 10 via an insulated delivery system indicated generally the reference numeral 13. The freeze cylinder 12, one type of which is described in greater detail below with reference to FIGS. 9 to 12 is cooled by a remote refrigeration unit 14.

A product cylinder 15 containing a pre-mixed beverage, which may be, for example, a spirit diluted with a flavouring and water, is attached via line 16 to a source (not shown) of compressed gas e.g. air or carbon dioxide, by which the beverage may be driven to the tap 10 when the latter is opened. An outlet from product cylinder 15 leads via line 17 to a carbonator 18 in which the beverage is carbonated on its way to the freeze cylinder 12 via line 20. Where, as is the case here, the compressed gas used is carbon dioxide, the same source of gas may also supply carbon dioxide to the carbonator 18 via line 19. On opening dispense tap 10, pre-mix beverage from cylinder 15 is forced through the carbonator 18 to the freeze cylinder 12 where it forms the desired semi-frozen consistency and then travels through delivery system 13 to be dispensed through the tap 10.

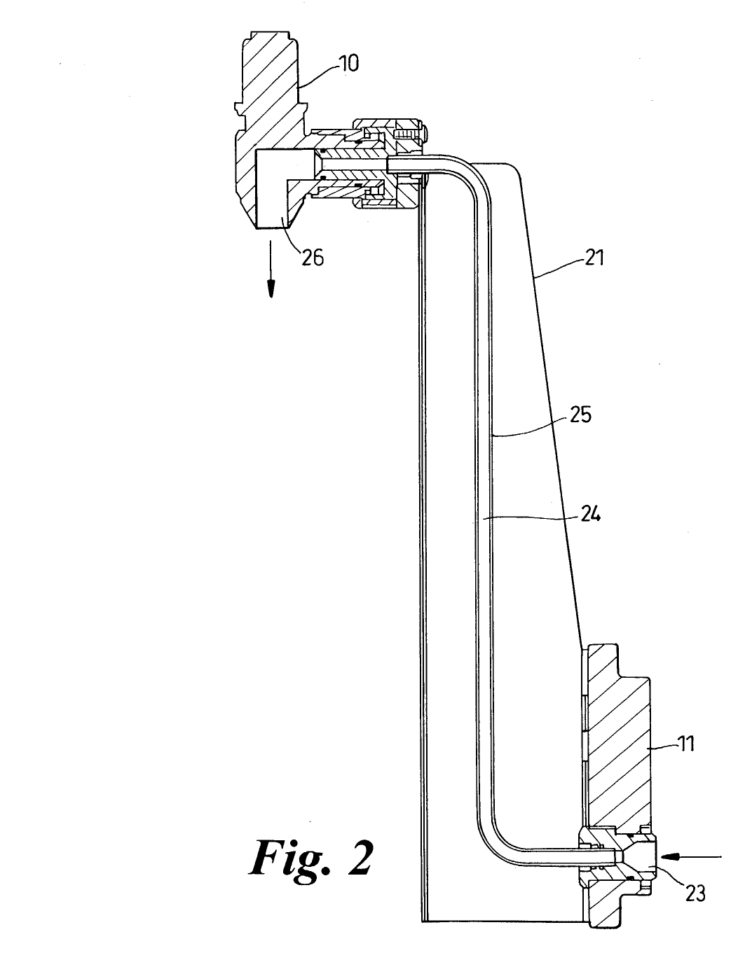

With reference now to FIG. 2, there is shown one form of delivery system 13 for the apparatus of FIG. 1 in which the flow line from the freeze cylinder (not shown in FIG. 2) to the dispense tap 10 is insulated. The dispense tap 10 is mounted at the upper end of a font housing 21, the font housing 21 being mounted on a bar top 11. An outlet 23 from the freeze cylinder is connected to the lower, inlet end of a delivery tube 24. At its upper, outlet end the delivery tube 24 is connected to the dispense outlet 25 of the tap 10. The tube 24 is encased in a suitable thermally-insulating sleeve 26 and/or surrounded by an insulation layer (not shown). In this way, beverage in a semi-frozen condition can be delivered from the freeze cylinder to the tap 10 for dispense in good condition into a glass (not shown) from a font-type dispense unit. By way of example only, the delivery tube 24 may be a standard food grade stainless steel tubing of outside diameter ¼ inch (6.35 mm) or ⅜ inch (9.5 mm). The delivery tube 24 may have a vertical extent of, say about 400 to 450 mm so that the tap 10 be mounted a similar height above the bar top. Where the delivery tube 24 is encased in an insulation layer, 25 mm thick foam insulation may be used.

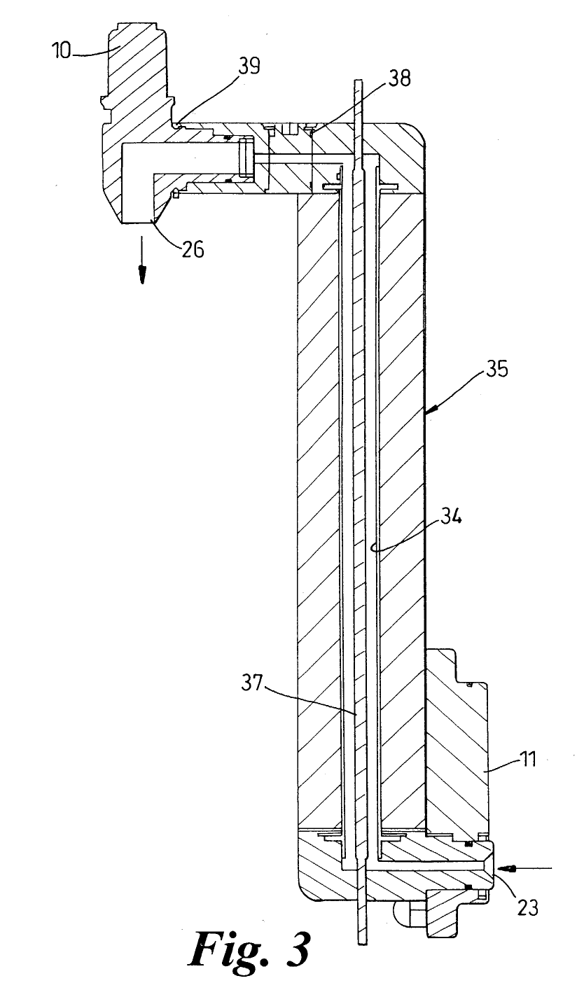

Referring now to FIG. 3, there is shown another delivery system 13 for the apparatus of FIG. 1 similar to that of FIG. 2 but in which the delivery tube 24 is provided with additional cooling. Dispense tap 10 is again mounted above a bar top 11 and is connected to the outlet 23 of the freeze cylinder (not shown in FIG. 3) by a substantially vertical delivery tube 34. A coolant tube 37 passes through the entire vertical extent of tube 34. A coolant mixture, e.g. glycol and water, can be passed through tube 37, preferably in the opposite direction to the direction of flow of the beverage, to maintain the cooled temperature of the semi-frozen beverage in the delivery tube 34. An insulation layer 35 encases the delivery tube 34 to further assist in maintaining the desired temperature of the semi-frozen beverage so it is delivered to the tap 10 in good condition. At its upper end tube 34 leads to the dispense outlet 25 of tap 10 via an on-off valve 38. Valve 38 will be maintained open when the apparatus is in use but can be closed for easy removal of the tap 10 for cleaning by means of standard quick-release fitting 39. By way of example only, tubes 34,37 are made of food grade material and the coolant tube 37 may be of ⅜ inch diameter with the delivery tube 34 of 28 mm diameter. The delivery tube 34 may have a vertical extent of, say about 400 to 450 mm so that the tap 10 may be mounted a similar height above the bar top. 25 mm thick foam insulation may be used for the insulation layer.

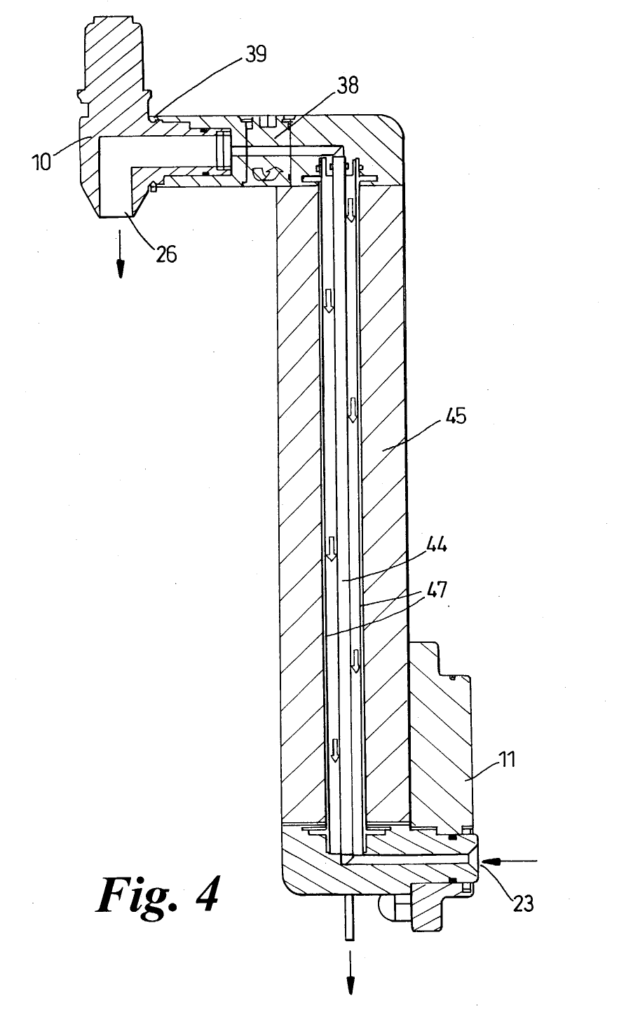

With reference now to FIG. 4, there is shown yet another delivery system 13 for the apparatus of FIG. 1 in which additional cooling is provided with a coolant similar to that of FIG. 3. Dispense tap 10 is again mounted above a bar top 11 and is connected to the outlet 23 of the freeze cylinder (not shown in FIG. 4) by a substantially vertical delivery tube 44. The vertical extent of delivery tube 44 is contained within an annular coolant tube 47. A coolant mixture e.g. glycol and water can be passed through tube 47, preferably in the opposite direction to the direction of flow of the beverage, as indicated by the arrows to maintain the cooled temperature of the semi-frozen beverage in the delivery tube 44. An insulation layer 45 encases the coolant tube 47 to further assist in maintaining the temperature of the semi-frozen beverage so it is delivered to the tap 10 in good condition. At its upper end, tube 44 leads to the dispense outlet 25 of tap 10 via an on-off valve 38. Valve 38 will be maintained open when the apparatus is in use but can be closed for removal and cleaning of tap 10 which, again, is attached by means of quick-release coupling 39. By way of example only, the delivery tube 44 may be standard food grade stainless steel tubing of outside diameter ¼ inch (6.35 mm) or ⅜ inch (9.5 mm). The coolant tube 47 may be of 22 mm outside diameter. The delivery tube 44 may have a vertical extent of, say about 400 to 450 mm so that the tap 10 may be mounted a similar height above the bar top. 25 mm thick foam insulation may again be used the insulation layer

In the above-described embodiments, a pre-mixed carbonated beverage in product cylinder 15 is supplied to the freeze cylinder 12 from where it is delivered in a semi-frozen condition to the remote dispense tap 10 via delivery system 13 designed to maintain the beverage in the desired semi-frozen condition. Thus, the beverage dispensed from the tap 10 is the same as that contained in the product cylinder 15 but with the physical condition altered from liquid to semi-frozen. In a modification (not shown), the product cylinder 15 may contain a base liquid, for example a spirit diluted with water, that is delivered to the freeze cylinder 12 via the carbonator 18 where it is mixed with one or more additional components such as a syrup concentrate supplied to the freeze cylinder 12 from a separate source to produce the beverage. In this way, mixing of the beverage occurs within the freeze cylinder 12 which may have advantages for particular beverages where storing the pre-mixed component in product cylinder 15 may be a problem, for example if the pre-mixed components separate within the cylinder 15 so that the product drawn off may vary. As will be appreciated, whichever of these methods is employed, the semi-frozen beverage supplied to the tap 10 is the same for each dispense and a separate apparatus is required for dispensing more than one type of semi-frozen beverage.

FIG. 5 shows a modification to the apparatus of FIG. 1 that can be used to dispense a variety of different semi-frozen beverages. For convenience, like reference numerals are used where appropriate to indicate parts corresponding to those described previously. The product cylinder 15 contains a base liquid, for example a spirit diluted with water, that is passed via carbonator 18 to the freeze cylinder 12 where it is converted to the desired semi-frozen condition. From freeze cylinder 12, the semi-frozen base liquid is supplied to dispense tap 10 via a flow line 70 which may consist of any of the delivery systems 13 already described herein. As shown, the semi-frozen base liquid supplied to the tap 10 may be mixed with one or more additional beverage components supplied to the tap 10 from a dosing system 71 via line 72. The additional components may be flavourings, e.g. syrup concentrates, spirits, e.g. vodka, gin etc or any other beverage component that may be added to modify the base-liquid. The dosing system 71 may comprise a manifold connected to separate sources for each additional beverage component with individual valves controlling the addition of each component to the semi-frozen base liquid for dispense of the desired beverage from the tap 10. As will be appreciated, this arrangement allows selection and dispense of different beverages, e.g. cocktails, by adding one or more components to the same base liquid. In this way, the apparatus can produce a range of beverages according to user choice.

The selection and addition of such components may be achieved via a control system which allows the user to select a desired beverage and operates the appropriate valves to release the required components for addition to the base liquid. For example, a control pad with touch, push or dial selection may be provided for the user to select and input a desired beverage. The release of the additional component(s) may be controlled so that dosing begins with or slightly after initial dispense of the semi-frozen base liquid from the tap 10 and ends before the dispense of semi-frozen base liquid. In this way, the semi-frozen base liquid flushes the tap 10 during the final part of the dispense cycle so that no trace of the additional components remains in the tap 10 which could contaminate the next dispense. As a further safeguard against contamination, a non-return valve 73 may be provided upstream of the part where additional components are introduced to prevent back-flow into the delivery system 13. In the above-described embodiments, the distance the tap 10 can be spaced from the freeze cylinder 12 may be limited by the length of the delivery tube that can be employed to maintain the semi-frozen beverage in good condition for dispense from tap 10.

Referring now to FIG. 6, there is shown another arrangement for remotely connecting the tap 10 to the freeze cylinder 12 with a dosing unit 71 for release of additional beverage component(s) to a semi-frozen base liquid supplied to the tap 10 from the freeze cylinder 12. In this arrangement, the flow line for supply of semi-frozen base liquid from the freeze cylinder 12 to the dispense tap 10 is in the form of a re-circulation loop 80. As shown, the dispense tap 10 and dosing system 71 are connected to the recirculation loop 80 via a non-return valve 73 and a pump 81 is provided to pump the semi-frozen base liquid around the loop 80 back to the freeze cylinder 12. Returning the semi-frozen base liquid to the freeze cylinder 12 for re-freezing and re-circulation assists in maintaining the base liquid in the desired semi-frozen condition for each dispense and may allow the tap 10 to be positioned further from the freeze cylinder 12 than the previous embodiments. The operation of dosing unit 71 to provide a range of beverages from a common semi-frozen base liquid is the same as described previously.

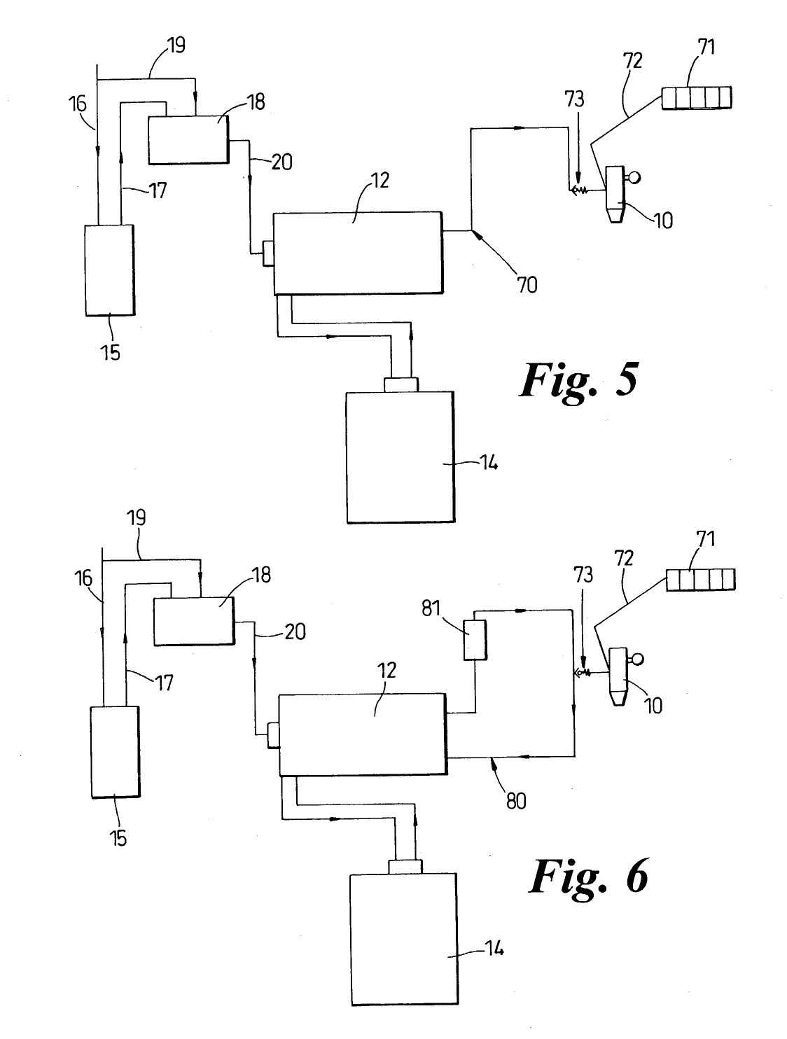

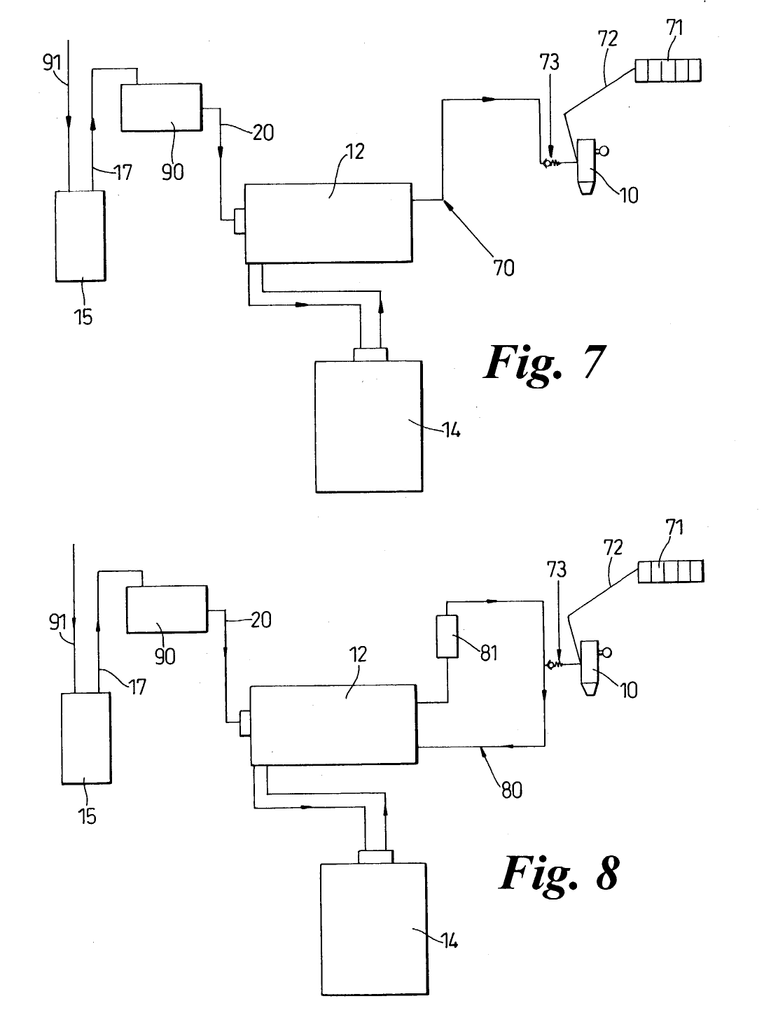

The embodiments of the apparatus above-described are suitable for dispensing semi-frozen carbonated beverages. FIGS. 7 and 8 show embodiments of apparatus similar to FIGS. 5 and 6 that are suitable for dispensing non-carbonated beverages. In these embodiments, the carbonator 18 is omitted and may be replaced by a pump 90 and/or a supply 91 of non-carbonated gas such as nitrogen connected to the product cylinder 15 to drive the base liquid through the apparatus in response to opening tap 10. In other respects, the operation of these arrangements is similar to that of FIGS. 5 and 6 and will be understood from the description of those embodiments. It will be understood that the apparatus of FIG. 1 could also be adapted to provide dispense of a non-carbonated beverage in similar manner.

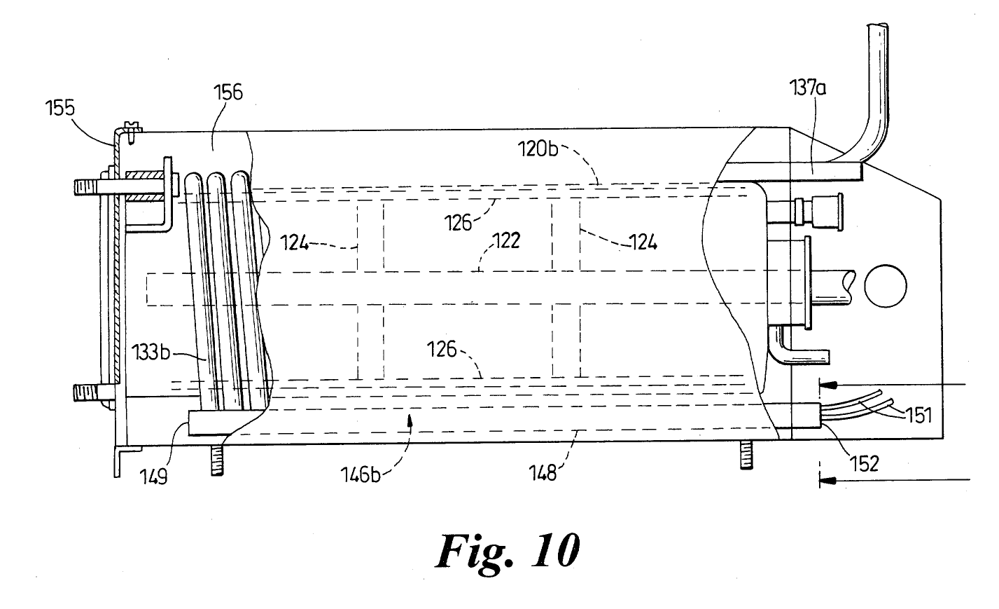

Referring to FIGS. 9 to 12 there is shown a freezing unit 100 suitable for use in the apparatus of the invention. The unit 100 has a freeze cylinder box 116 containing two beverage cylinders 120a and 120b. The box 116 has a harvesting assembly drive or beater motors (not shown) for each cylinder 120a, 120b. Each cylinder 120a, 120b includes a scraper or harvesting assembly having a central axial rod 122, scraper blade support beater bars 124 and scraper blades 126 pivotally secured to beater bars 124. Each cylinder 120a, 120b has a heat transfer coil 133a, 133b (the latter only being visible in FIG. 10). Refrigerant or coolant is delivered to coils 133a, 133b and may flow from the coils to a common outlet. Temperature sensors may be positioned to the coolant inlet and outlet lines. As best seen in FIG. 10, heat transfer coil 133b encircles cylinder 120b and it will be understood that heat transfer coil 133a likewise encircles cylinder 120a. Two pairs of heaters 146a and 146b having stainless steel tube bodies 148 sealed at one end 149, are welded to the individual coils 133a and 133b respectively. It can be seen by referring to FIG. 11 that heater pairs 146a and 146b are secured to their respective coils 133a and 133b at positions thereon approximating to five and seven o'clock around the perimeter thereof.

Each heater 146a and 146b includes a heating element 150 having wires 151 for connection to a source of electrical power. Tube bodies 148 have an inside sized to allow for slideable insertion of elements 150 therein. In addition, it has been found desirable to plate the surfaces of the tubes 148 with copper to provide for improved heat dispersion. Heaters 146a and 146b extend substantially along the entire length of heat transfer coils 133a and 133b and terminate with open ends 152 of the heater bodies 148 arranged externally of rear plate 154 of cylinder box 116 (see FIGS. 10 and 11). Thus means are provided to defrost the unit 100 when necessary. As is known in the art, after cylinders 120a and 120b, and associated heat transfer coils 133a and 133b, and heaters 146a and 146b are secured to cylinder box front surface plate 155 and rear plate 154, the remaining interior or void areas of cylinder box 116 may be filled with a foam insulation 156.

It will be appreciated that the invention is not limited to the embodiments shown and described herein. The heater elements of the freezer unit of FIGS. 9 to 12 are not essential. Where defrost means are desired to be used, other conventionally available means may be employed. Means to defrost may be provided for example by passing liquid whose temperature is above that of the semi-frozen beverage through the heat transfer coils. Suitable liquids include water or a glycol/water mixture. In an alternative means, heated refrigerant gas may be passed through the heat transfer coils. A single freeze cylinder or a greater number of freeze cylinders may be employed depending on the dispense quantities required. The freeze cylinder or cylinders may either be remote from or adjacent to the refrigerant or coolant supply. The apparatus of FIG. 1 could be modified to employ a recirculation loop without dosing of additional components where such re-circulation is beneficial to maintain the condition of the semi-frozen beverage. More than one dispense tap may be connected to a re-circulation loop allowing the apparatus to provide dispense of semi-frozen beverage at different locations. Where provided, the dosing unit may be provided with any number of additional components for addition to a common base liquid. Other modifications and changes will be apparent to those skilled in the art that will not exceed the spirit and scope of the invention as is defined by the claims herein.

In the claims:

1. An apparatus for making and dispensing a semi-frozen beverage comprising:
a means for freezing a liquid to a desired semi-frozen state and retaining a volume of said semi-frozen beverage therein,
a flow line from the freezing means to a dispense tap, the dispense tap being mounted remotely from the freezing means so that said semi-frozen beverage can flow through the flow line and be dispensed at the remote location from the tap by operation thereof, and the flow line being insulated and having a cooling line in heat exchange contact therewith for maintaining of the semi-frozen beverage in its semi-frozen state.

2. The apparatus according to claim 1 wherein the coolant tube is arranged inside the delivery tube so that the coolant is surrounded by the beverage in the delivery tube.

3. The apparatus according to claim 1 wherein the delivery tube is arranged inside the coolant tube so that the coolant surrounds the beverage in the delivery tube.

4. The apparatus according to claim 1 wherein the flow line takes the form of a re-circulation loop for returning semi-frozen beverage to the means for making and retaining a volume of semi-frozen beverage

5. The apparatus according to claim 1 wherein the dispense tap is removably connected to the flow line by a shut-off valve that is normally maintained open but which can be closed for removal of the tap for cleaning.

6. The apparatus according to claim 1 wherein the flow line is a rigid tube.

7. The apparatus according to claim 1, and where the flow line is a flexible tube of food grade material.

8. The apparatus according to any one of claim 4 wherein a pump is provided in the re-circulation loop to assist flow of the semi-frozen beverage around the loop.

9. Apparatus according to any one of claim 4 wherein one or more taps are connected at any point around the re-circulation loop.

10. An apparatus for making and dispensing a semi-frozen beverage comprising:
a means for freezing a liquid to a desired semi-frozen state and retaining a volume of said semi-frozen beverage therein,
a dispense tap for selectively dispensing the semi-frozen beverage from the means for freezing the liquid and storing the semi-frozen beverage,
a dosing machine for dosing one or more flavourings into a base semi-frozen beverage as the semi-frozen beverage is being dispensed from the tap.

11. The apparatus according to claim 10 wherein the dosing unit is controlled in response to user selection of a desired beverage to add one or more of the one or more flavourings to the base semi-frozen beverage.

12. The apparatus according to claim 10 wherein the user can select one or more of the one or more flavourings to create a semi-frozen beverage of their choice.

13. The apparatus according to claim 10 wherein the dosing unit comprises a manifold having separate inlets for each one or more flavouring and having one or more valves for each of the one or more flavourings for controlling the addition thereof to the base semi-frozen beverage.

14. The apparatus according to claim 13 wherein the one or more valves are arranged to open when the tap is opened or shortly thereafter and to close before dispense is completed to flush the system with the semi-frozen beverage and remove any trace of the added one or more flavourings.

15. A method of dispensing a semi-frozen beverage comprising the steps of providing a supply of a liquid, delivering the liquid to a freezing unit, converting the liquid to a semi-frozen condition in the freezing unit, delivering the semi-frozen liquid to a remote dispense tap and optionally dosing the semi-frozen liquid delivered to the dispense tap with one or more additional components to produce a desired semi-frozen beverage for dispense from the tap.

16. The method according to claim 15 wherein the dispense tap is connected to a re-circulation loop and further including the step of returning semi-frozen liquid to the freezing unit.
